(19) United States
(12) Patent Application Publication
(10) Pub. No.: US 2010/0013738 A1
(43) Pub. Date: Jan. 21, 2010

(54) IMAGE CAPTURE AND DISPLAY CONFIGURATION

(76) Inventors: Edward Covannon, Ontario (CA); Amy D. Enge, Spencerport, NY (US); John R. Fredlund, Rochester, NY (US)

Correspondence Address: J. Lanny Tucker;Patent Legal Staff, Eastman Kodak Company, 343 State Street, Rochester, NY, 14650-2201, US

(21) Appl. No.: 12/173,201

(22) Filed: Jul. 15, 2008

(51) Int. Cl. G09G 3/00; G09G 5/00; G06K 9/00; H04N 5/232

(52) U.S. Cl. 345/1.3; 345/31; 382/276; 348/211.8; 348/E05.042

(57) ABSTRACT

A method for coordinating presentation of multiple perspective content data for a subject scene receives separate display perspective signals, each corresponding to one of a plurality of display segments and processes each of the separate display perspective signals to generate a corresponding content configuration data request. At least one image-content generating device is configured according to the corresponding content configuration data request. Image data content of the subject scene is obtained from the at least one image-content generating device.

### CROSS REFERENCE TO RELATED APPLICATIONS

Reference is made to the following co-pending commonly assigned applications:

U.S. patent application Ser. No. 11/876,95, filed on Oct. 23, 2007, by Enge et al., entitled “Three-Dimensional Game Piece”;

U.S. patent application Ser. No. 10/269,258, Patent Application Publication US 2004/0070675, filed on Oct. 11, 2002 by Fredlund et al., entitled “System and Method of Processing a Digital Image for Intuitive Viewing”; and

U.S. patent application Ser. No. 11/649,972, filed on Jan. 5, 2007, by Fredlund et al., entitled “Multi-frame Display System with Perspective Based Image Arrangement”.

### FIELD OF THE INVENTION

This invention generally relates to image display and more particularly relates to methods for coordinating the presentation of image content where there are multiple content-generating and content display devices.

### BACKGROUND OF THE INVENTION

In conventional practice, a cathode-ray tube (CRT), liquid-crystal display (LCD) screen, projection screen, or other display apparatus has a fixed aspect ratio and a view angle that determines its display format. The conventional camera or other image sensor or, more generally, content generation apparatus, that communicates with the display apparatus then provides image content with a perspective that is suited to the given display format. For many types of imaging, this standard arrangement is satisfactory, and there may be no incentive for easing the resulting constraints on image capture and display.

For some types of imaging, however, constraints to image size, aspect ratio, and view angle limit the usability and value of the overall viewing experience. This is particularly true where additional perspective is desired. For example, conventional single-screen display formats are not well suited for panoramic viewing. Instead, multiple displays must be arranged side-by-side or in an otherwise tiled manner, each image at a slightly different perspective, in order to provide the needed aspect ratio. A similar tiled arrangement of flat displays is also needed for walk-around displays, such as spherical or cylindrical display housings that allow 360 degree viewing, so that viewers can see different portions of a scene from different points around the display.

Perspective viewing techniques for images obtained from multiple synchronized cameras have been used in cinematic applications, providing such special effects as “bullet time” and various slowed-motion effects. In general, a fixed array of cameras or one or more moving cameras can be used to providing a changing perspective of scene content. This technique provides a single image frame that exhibits a continually changing perspective.

Commonly assigned U.S. Patent Application Publication 2004/0070675, noted earlier, describes a system that allows intuitive viewing of an obtained image according to movement of a display or to movement of a user with respect to the display. Movement of the display, for example, is detected to influence navigation within the obtained image using this technique. The displayed view is thus updated according to operator control of display position and related zoom and pan controls.

The commonly assigned application entitled “Multi-frame Display System with Perspective Based Image Arrangement” describes an array of multiple displays that provide a sequence of multiple digital image frames that can include images obtained at different times or at different perspectives, according to the orientation of the individual display devices. However, this method is constrained to assigned or detected display positions and uses only images that have been previously obtained and stored.

For displays in general, however, (other than for integral camera viewfinders or viewfinder displays and the like), there is typically no real-time positional coordination of the display and of its corresponding camera or other type of image-content generating device. That is, the spatial position and perspective of the camera relative to its subject, as the image is being obtained, is generally unrelated to the spatial position of the display and, as a result, the spatial position of the viewer. Often, there is no need for such coordination. As a simple example, the camera that is zooming toward the subject, a baseball batter at the plate, may be facing due West, while the viewer watches the ball game on a display screen that faces North-Northeast. It can be appreciated that for this simple example, it would not be necessary or desirable for the viewer to face the same direction as the camera faces. Continuing with this example, it can be appreciated that coordination of spatial position for both camera and display in many cases would even be a genuine disadvantage. Should the camera position shift to behind the pitcher, a viewing fan would need to scurry to another side of the room, quickly turning the display screen accordingly while on the way.

Although the preceding example may seem unusual, it points out a principle and illustrates expectations that are common to the viewer of a display, namely that the spatial position of the display need not correspond in any necessary way to the spatial position of the camera. Existing methods for image display, such as that described in the '0675 application, do not dynamically link the position of the display with the position of the image capture device.

There are some types of imaging applications, however, for which such conventional models may be constraining, and where some correspondence between spatial positions of both display and content-generating devices currently obtaining the image content may be beneficial. This can be particularly true where there is more than one display device. Conventional methods are constrained, for example, for displaying three-dimensional objects from multiple different perspectives. A display arrangement that uses multiple screens is not adapted positionally at the same time as scene content changes. Conversely, there are situations for which an arrangement of multiple cameras or sensors has no spatial correspondence with positioning of a corresponding set of displays that present the images that are currently being obtained.

Thus, it is seen that for capturing and presentation of content at different perspectives from multiple image-content generating devices, there can be a need for providing a suitable arrangement of corresponding display devices and for improved coordination between image-content generating and display devices.

### SUMMARY OF THE INVENTION

The invention is defined by the claims. It is an object of the present invention to advance the art of image display, particularly for image content that is obtained at multiple perspectives. With this object in mind, the present invention provides a method for coordinating presentation of multiple perspective content data for a subject scene, comprising:
receiving separate display perspective signals, each corresponding to one of a plurality of display segments;
processing each of the separate display perspective signals to generate a corresponding content configuration data request;
configuring at least one image-content generating device according to the corresponding content configuration data request; and
obtaining image data content of the subject scene from the at least one image-content generating device.

In another aspect, the present invention provides a method for coordinating presentation of multiple perspective content data, comprising:
obtaining image data content representative of a subject scene from each of at least one image-content generating device, wherein the image data content comprises configuration data related to at least the spatial position of the image-content generating device;
configuring the spatial position of at least one display segment according to the configuration data; and
displaying an image on the at least one display segment according to the obtained image data content.

Embodiments of the present invention provide enhanced perspective viewing under conditions in which the viewer is in a relatively fixed position and the subject scene surrounds the viewer or, alternately, when the subject scene is centered, and the viewer can observe it from more than one angle.

The invention, and its objects and advantages, will become more apparent in the detailed description of the preferred embodiment presented subsequently.

### BRIEF DESCRIPTION OF THE DRAWINGS

In the detailed description of the preferred embodiment of the invention presented following, reference is made to the accompanying drawings, in which:

FIG. 1 is a block diagram of an image production system;

FIG. 2 is a block diagram showing data flow to and from an image production system;

FIG. 3 is a block diagram showing input to an image production system;

FIG. 4 is a block diagram showing image sources input to an image production system;

FIG. 5 is a block diagram showing audio sources input to an image production system;

FIG. 6 is a block diagram showing image capture sources input to an image production system;

FIG. 7 is a block diagram showing output from an image production system;

FIG. 8 is a plan view showing a scene with multiple parts;

FIG. 9 shows a wall with a window in one embodiment;

FIG. 10 is a logic flow diagram that shows steps for displaying an image where there are multiple displays in one embodiment;

FIG. 11 is a hybrid top and front view that represents the position of system components and scene content for one embodiment;

FIG. 12 is a plan view showing multiple displays with image content;

FIG. 13 is a block diagram that shows an imaging apparatus in an embodiment wherein the subject scene is generally centered;

FIG. 14 is a block diagram that shows movement of a display segment and its corresponding image-content generating device;

FIG. 15 is a schematic diagram showing the various control, feedback, and data signals used for positioning image-content generating devices and their corresponding display segments in one embodiment;

FIG. 16 is a schematic diagram showing the various control, feedback, and data signals and steps used for re-positioning an image-content generating device according to the re-positioning of a display segment in one embodiment;

FIG. 17 is a schematic diagram showing the various control, feedback, and data signals and steps used for re-positioning a display segment according to the re-positioning of an image-content generating device in one embodiment; and

FIG. 18 is a schematic diagram showing an embodiment of the present invention for three-dimensional (3-D) viewing.

### DETAILED DESCRIPTION OF THE INVENTION

An “image-content generating device” provides image data for presentation on a display apparatus. Some examples of image-content generating devices include cameras and hand-held image capture devices, along with other types of image sensors. Image-content generating devices can also include devices that synthetically generate images or animations, such as using computer logic, for example. An image-content generating device according to the present invention is capable of having its position or operation adjusted according to a “content configuration data request”.

The term “perspective” has its generally understood meaning as the term is used in the imaging arts. Perspective relates to the appearance of an image subject or subjects relative to the distance from and angle toward the viewer or imaging device.

The term “multiple perspective content data” describes image data taken from the same scene or subject but obtained at two or more perspectives.

The term “display configuration data” relates to operating parameters and instructions for configuring a display device and can include, for example, instructions related to the perspective at which image content is obtained, such as viewing angle or position and aspect ratio, as well as parameters relating to focus adjustment, aperture setting, brightness, and other characteristics.

The term “display perspective request” relates to information in a signal that describes the perspective of an image to be presented on the display.

The term “subject scene” relates to the object about which image data is obtained. In optical terminology, the subject of an imaging device is considered to be an object, in the object field. The image is the representation of the object that is formed within the camera or other imaging device and processed using an image sensor and related circuitry.

The system and method of the present invention address the need for simultaneous presentation of image content, for the same subject scene, at a number of different perspectives. The system and methods of the present invention coordinate the relative spatial position and image capture characteristics of each of a set of cameras or other image-content generating devices with a corresponding set of display segments. By doing this, embodiments of the present invention enable the presentation of multiple perspective content data in ways that enable a higher degree of viewer control over and appreciation of what is displayed from an imaged scene or subject.

The phrases “data processing device” or “data processor” are intended to include any data processing device, such as a central processing unit (“CPU”), a microcomputer, a desktop computer, a laptop computer, a mainframe computer, a personal digital assistant, a Blackberry™ or similar device, a digital camera, cellular phone, or any other device for processing data, managing data, or handling data. The data processing device can be implemented using logic-handling components of any type, including, for example, electrical, magnetic, optical, biological, or other components.

The phrase “processor-accessible memory” has its meaning as conventionally understood by those skilled in the data processing arts and is intended to include any processor-accessible data storage device, whether it employs volatile or nonvolatile, electronic, magnetic, optical, or other components and can include, but would not be limited to storage diskettes, hard disk devices, Compact Discs, DVDs, or other optical storage elements, flash memories, Read-Only Memories (ROMs), and Random-Access Memories (RAMs).

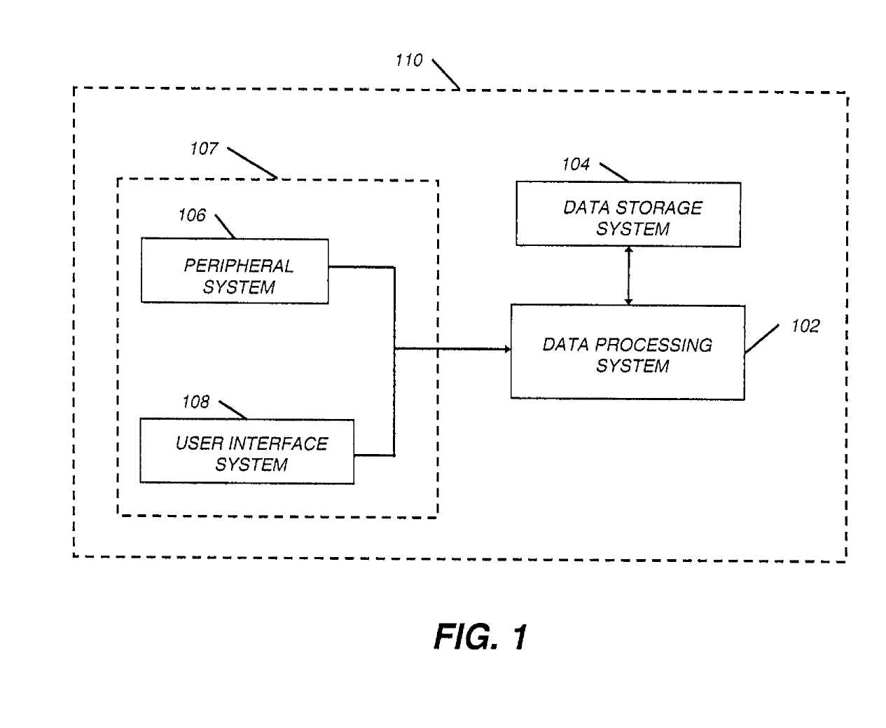

The block diagram of FIG. 1 shows a conventional image production system 110 that can be used for control of imaging operation according to one embodiment. Image production system 110 includes a data processing system 102 that provides control logic processing, such as a computer system, a peripheral system 106, a user interface system 108, and a data storage system 104, also referred to as a processor-accessible memory. An input system 107 includes peripheral system 106 and user interface system 108. Data storage system 104 and input system 107 are communicatively connected to data processing system 102.

Data processing system 102 includes one or more data processing devices that implement the processes of the various embodiments of the present invention, including the example processes described in more particular detail herein. Data storage system 104 includes one or more processor-accessible memories configured to store the information needed to execute the processes of the various embodiments of the present invention. Data-storage system 104 may be a distributed system that has multiple processor-accessible memories communicatively connected to data processing system 102 via a plurality of computers and/or devices. Alternately, data storage system 104 need not be a distributed data-storage system and, consequently, may include one or more processor-accessible memories located within a single computer or device.

The phrase “communicatively connected” is intended to include any type of connection, whether wired or wireless, between devices, data processors, or programs in which data may be communicated. Further, the phrase “communicatively connected” is intended to include a connection between devices and/or programs within a single computer, a connection between devices and/or programs located in different computers, and a connection between devices not located in computers at all, but in communication with a computer or other data processing device. In this regard, although data storage system 104 is shown separately from data processing system 102, one skilled in the art will appreciate that the data storage system 104 may be stored completely or partially within data processing system 102. Further in this regard, although peripheral system 106 and user interface system 108 are shown separately from data processing system 102, one skilled in the art will appreciate that one or both of such systems may be stored completely or partially within data processing system 102.

Peripheral system 106 may include one or more devices configured to provide information, including, for example, video sequences to data processing system 102 used to facilitate generation of output video information as described herein. For example, peripheral system 106 may include digital video cameras, cellular phones, regular digital cameras, or other computers. The data processing system, upon receipt of information from a device in peripheral system 106, may store it in data storage system 104.

User interface system 108 may include a mouse, a keyboard, a mouse and a keyboard, Joystick or other pointer, or any device or combination of devices from which data is input to data processing system 102. In this regard, although peripheral system 106 is shown separately from user interface system 108, peripheral system 106 may be included as part of user interface system 108.

User interface system 108 also may include a display device, a plurality of display devices (i.e. a “display system”), a computer accessible memory, one or more display devices and a computer accessible memory, or any device or combination of devices to which data is output by data processing system 102.

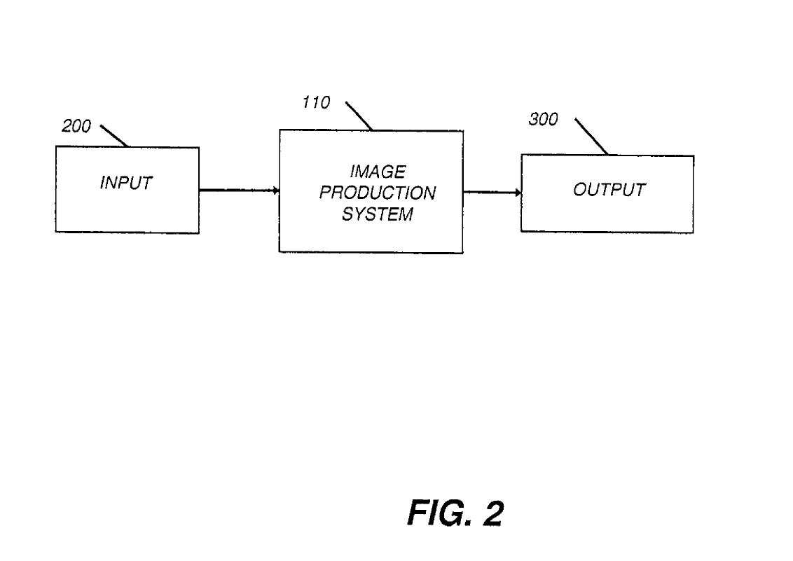

FIG. 2 illustrates an input/output diagram of image production system 110, according to an embodiment of the present invention. In this regard, input 200 represents information input to image production system 110 for the generation of output 300, such as display output. The input 200 may be input to and correspondingly received by data processing system 102 of image production system 110 via peripheral system 106 or user interface system 108, or both. Similarly, output 300 may be output by data processing system 102 via data storage system 104, peripheral system 106, user interface system 108, or combinations thereof.

As will be described in more detail subsequently, input 200 includes one or more input image data and, optionally, additional audio or other information. Further, input 200 includes configuration data. At least the configuration data are used by the data processing system 102 of the image production system 110 to generate the output 300. The output 300 includes one or more configurations generated by image production system 110.

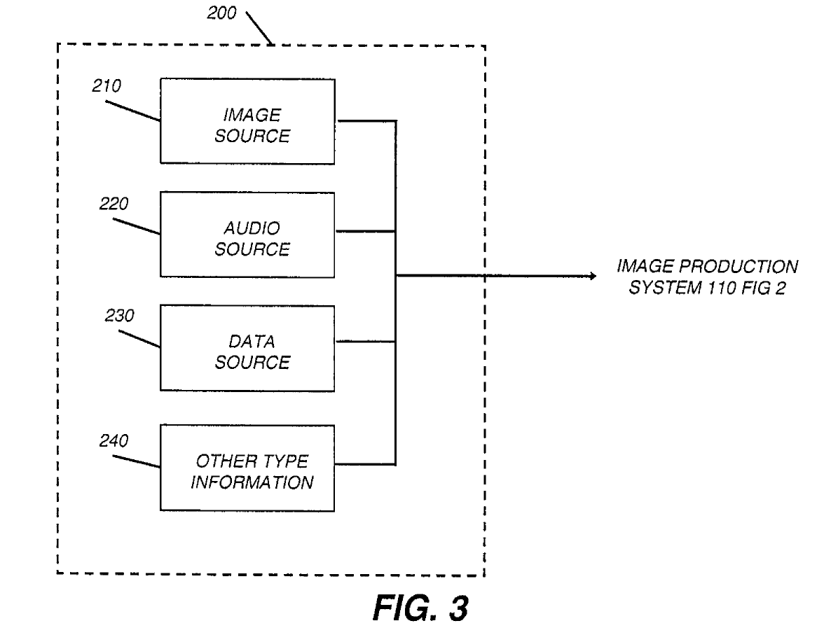

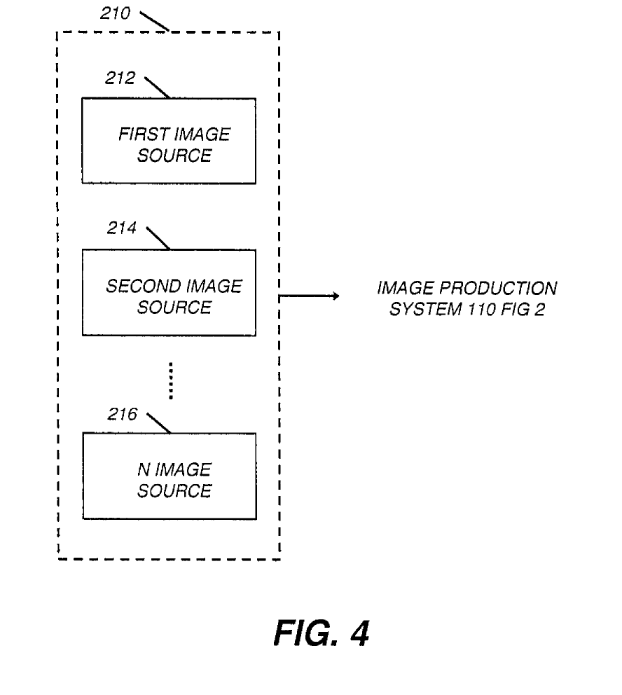

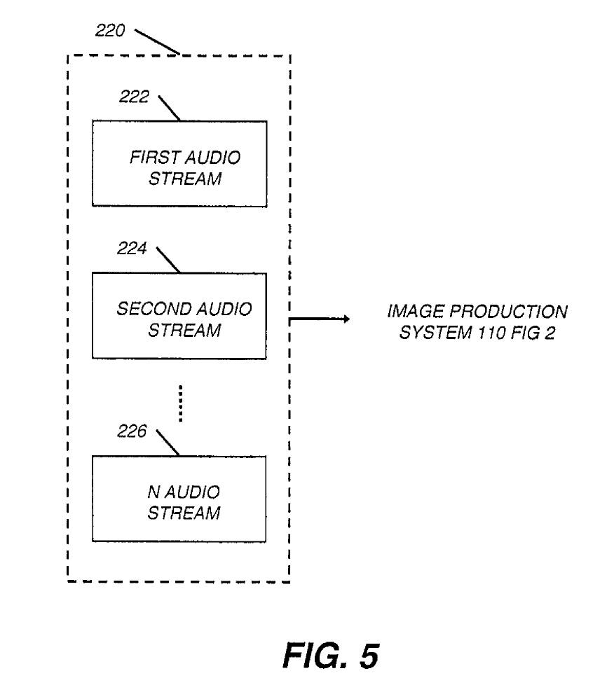

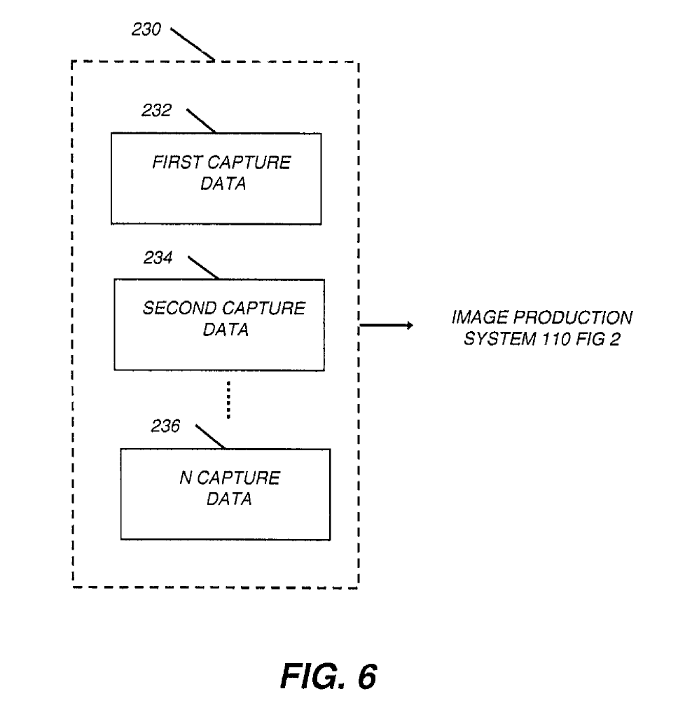

Referring to FIG. 3, input 200 is shown in greater detail, according to an embodiment of the present invention. In input 200, several information sources 210, 220, 230, 240 are shown that may be used by image production system 110 to generate output 300. Image source 210 includes one or more input images or image sequences elaborated upon with respect to FIG. 4, below. Optional audio source 220 includes one or more audio streams elaborated upon with respect to FIG. 5, described subsequently. Data source 230 includes configuration information used by data processing system 102 to generate output 300. Data source 230 is elaborated upon with respect to FIG. 6, below. Optionally, other information source 240 may be provided as input to image production system 110 to facilitate customization of the output 300. In this regard, such other information source 240 may provide auxiliary information that may be added to a final image output as part of output 300, such as multimedia content, music, animation, text, and the like.

Referring to FIG. 4, image source 210 is shown as including multiple image sources 212, 214, . . . 216, according to an embodiment of the present invention. One skilled in the art will appreciate, however, that image source 210 may include only a single image source. In the embodiment of FIG. 4, the multiple image sources include a first image source 212, a second image source 214, and, ultimately, an nth image source 216. These sources may originate from a single camera or video recorder, or several cameras or video recorders recording the same event. One skilled in the art will appreciate that image source 210 may also include computer created images or videos. At least some of the input image sources may also be cropped regions-of-interest from a single or multiple cameras or video recorders.

Referring now to FIG. 5, audio information 220 is shown as including multiple audio streams 222, 224, . . . 226, according to an embodiment of the present invention. One skilled in the art will appreciate, however, that audio information 220 may include only a single audio stream. In the embodiment of FIG. 5, the multiple audio streams include a first audio stream 222, a second audio stream 224, and, ultimately, an nth audio stream 226. These audio streams may originate from one or more microphones recording audio of a same event. The microphones may be part of a video camera providing image source 210 or may be separate units. One or more wide-view and narrow-view microphones may capture the entire event from various views. A number of wide angle microphones located closer may be used to target audio input for a smaller groups of persons-of-interest. In one embodiment, at least one of the customized output videos in the output 300 (FIG. 2) includes audio content from one of audio streams 222, 224, 226. In this regard, such an output video may include audio content from one or more of audio streams 222, 224, 226 in place of any audio content associated with any of the video sequences in image source 210.

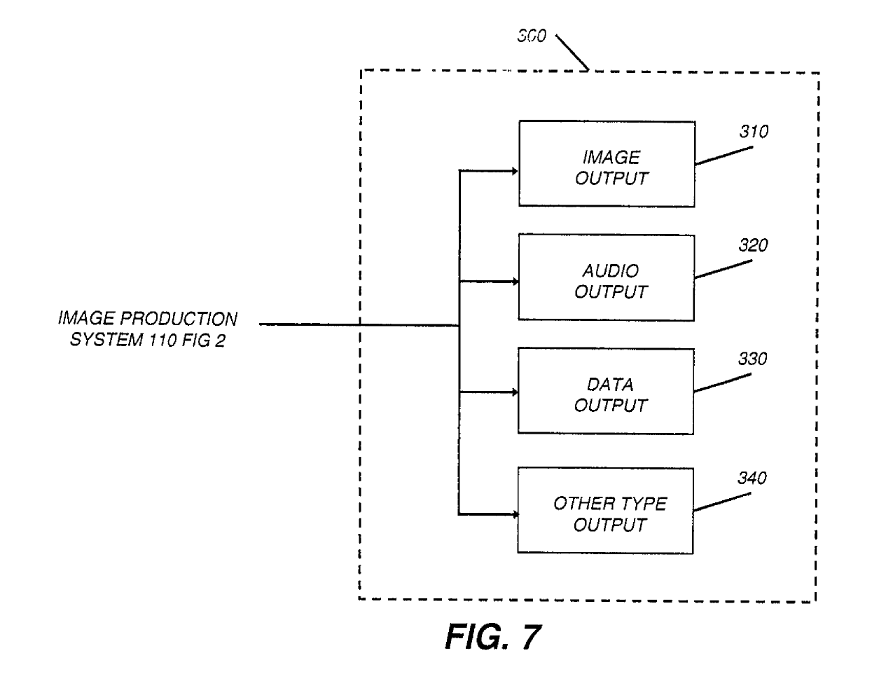

Referring to FIG. 6, data source 230 is shown to include a plurality of capture data 232, 234, . . . 236, according to an embodiment of the present invention. One skilled in the art will appreciate, however, that data source 230 may include only a single set of capture data, as will become more clear below, with respect to the discussion of FIG. 7. In the embodiment of FIG. 6, data source 230 includes a first capture data 232, a second capture data 234, and, ultimately, an nth capture data 236. The sets of capture data 232, 234, . . . 236 are used by data processing system 102 of image production system 110 to customize output videos in output 300. Note that captured data may take many forms including images and video. These visual data may be analyzed by production system 110 to determine positions of a viewer as well as positions of other image sources and/or displays.

Referring back to FIG. 3, information from other source 240 may include other identifiers of interest to create a corresponding customized output video, such as audio markers or lighting markers that signify the start or termination of a particular event, or additional media content (such as music, voice-over, animation) that is incorporated in the final output video. One skilled in the art will appreciate that additional content may include content for smell, touch, and taste as video display technology becomes more capable of incorporating these other stimuli.

The block diagram of FIG. 7 shows components of output 300 that are provided from image production system 110 (FIG. 2), including image output 310, audio output 320, data output 330, and other output 340.

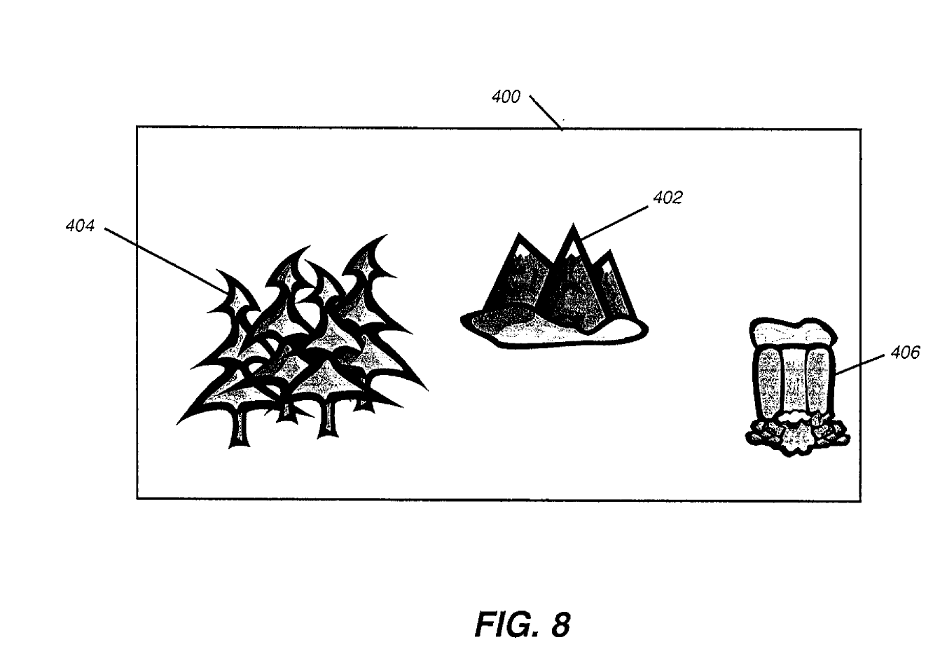

Referring now to FIGS. 8 through 12, there is shown an embodiment of the present invention in which a plurality of display segments and image-content generating devices are used to present multiple perspective content data. FIG. 8 shows a scene 400 that is the subject of interest, to be imaged at multiple perspectives. In this example, scene 400 has mountains 402, trees 404, and a waterfall 406.

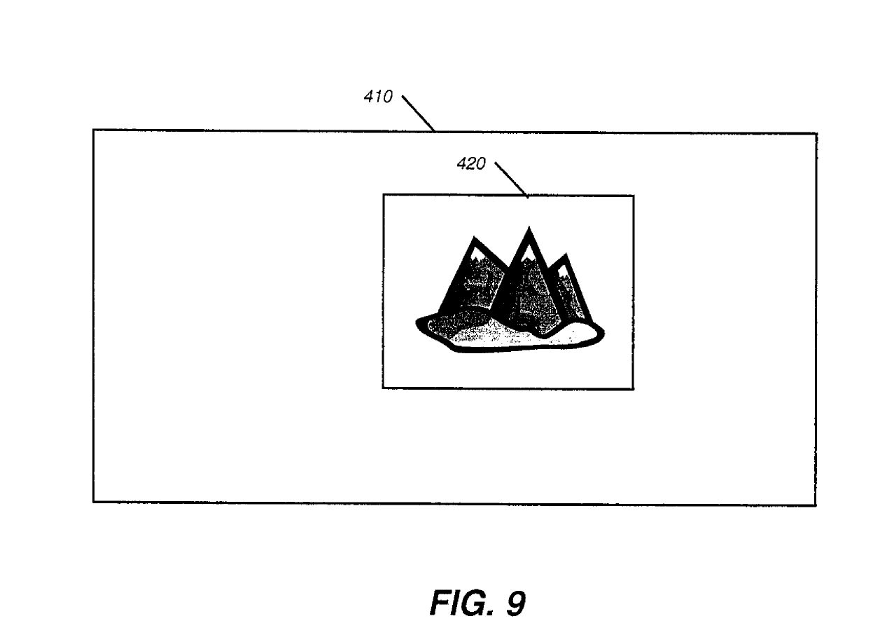

FIG. 9 shows what is visible from inside a building, through a conventional glass window 420, cut into a wall 410. Here, only a small part of scene 400, that is, mountains 402, are visible. In order to view the other parts of scene 400 from a particular viewpoint, without cutting out another window, it is necessary to place displays on suitable position along wall 410 as well as to aim externally mounted cameras toward the other portions of scene 400. It can also be important to account for parallax, considering the relative position of the viewer to the scene content.

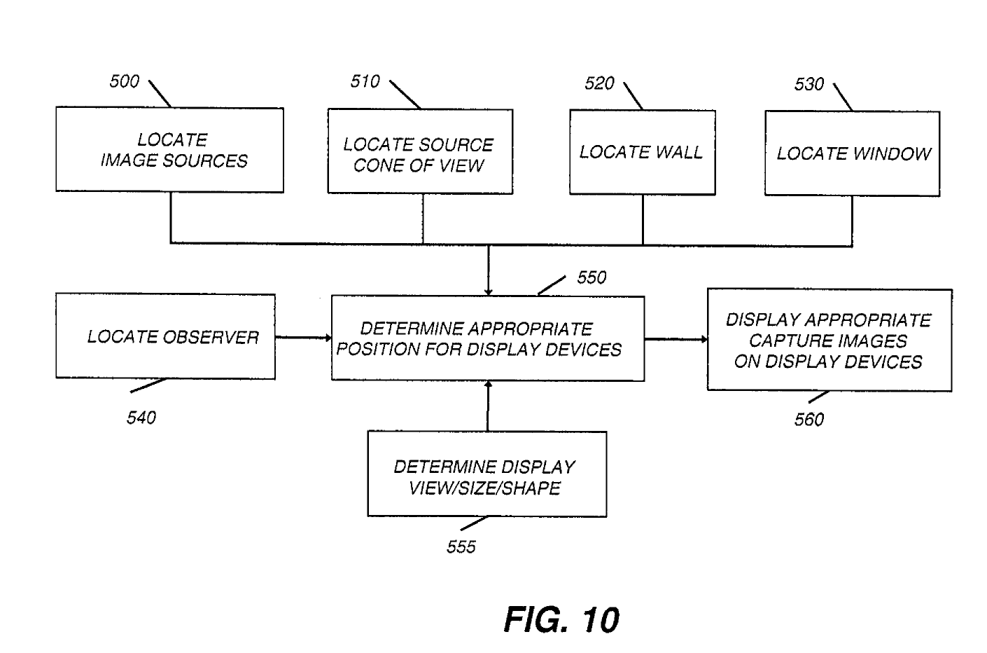

The workflow diagram of FIG. 10 shows steps that are part of the process that determines where to place another display on wall 410 as well as where to position cameras or other image-content generating devices. A locate step 500 obtains content configuration data relative to the position of image source 210 and its field of view and reports this information to data source 230. Locate source cone of view step 510 obtains the viewing angle for image source 210 and reports this information to data source 230. A locate wall step 520, a locate window step 530, and a locate observer step 540 locate these entities and report this information to data source 230. A determination step 550 computes the appropriate locations for display devices on wall 410. Step 550 determines not only where on the wall the display is mounted, but also determines the location of image sources, cone of view, and observer locations. A step 555 determines the display view, size, and shape. A display step 560 then displays the captured images. Step 560 can also include audio or multimedia content that is incorporated into the final output. It can be appreciated that the basic steps shown in FIG. 10 are exemplary and do not imply any particular order or other limitation.

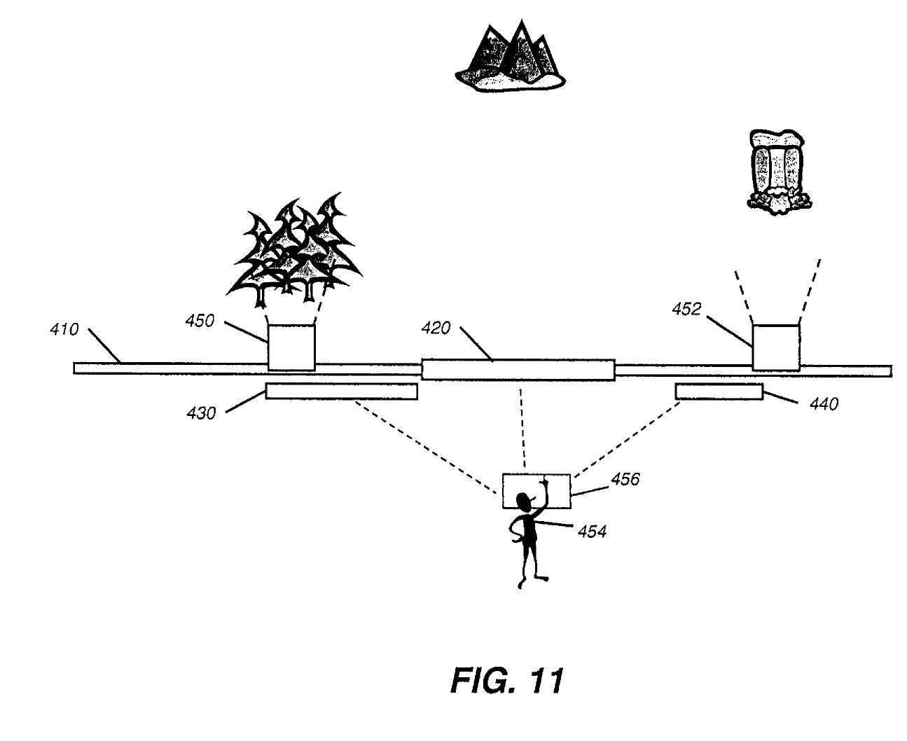

FIG. 11 shows a schematic view of the system of the FIG. 8 embodiment, with imaging components represented in top view, relative to a viewer 454, not shown in top view. Image-content generating devices 450 and 452 are positioned and operated according to the data that was generated using the basic steps described with reference to FIG. 10. One or more optional devices, such as laser pointing devices, for example, can be used to indicate suitable position for one or more displays, such as by displaying visible reference marks at the desired position(s) for display mounting.

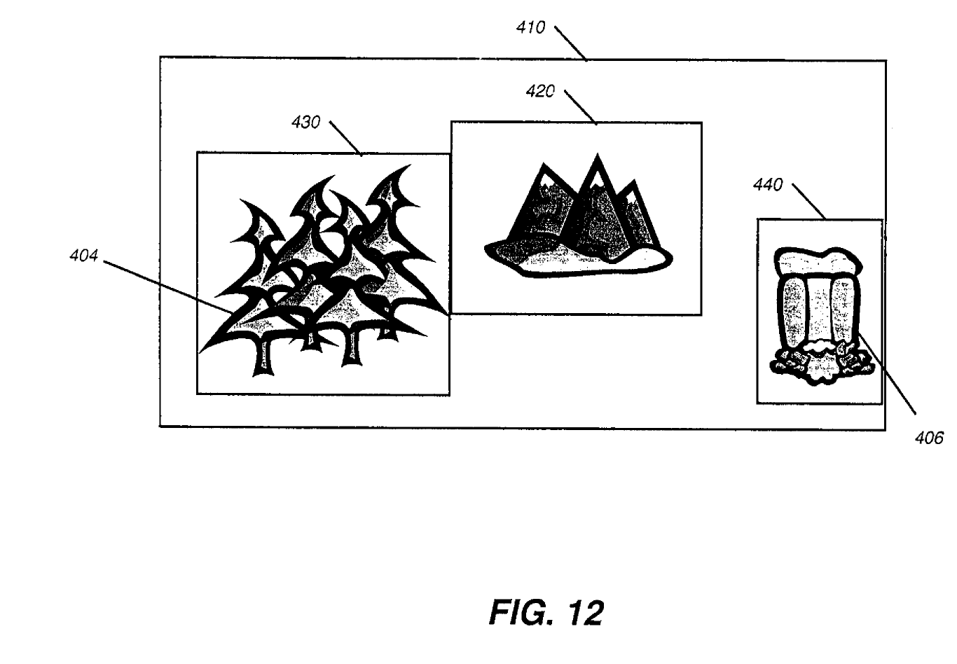

FIG. 11 shows displays 430 and 440 in position for showing trees 404 and waterfall 406. In order to determine the appropriate location for these displays, it is necessary to determine the distances between these viewed elements as they would display when viewed from a particular location. It is thus necessary to obtain and track the relative positions of both display devices 430, 440 and image-content generating devices 450 and 452. Methods for determining distance are well known in the imaging arts and can include, for example, assessment of contrast and relative focus or use of external sensors, such as infrared sensors or other devices, as well as simply obtaining viewer input or instructions for obtaining distance values. The plan view of FIG. 12 shows the resulting view for the observer with window 420 showing mountains 402, window 430 with trees 404, and window 440 with waterfall 406. As shown in FIG. 11, an optional viewer detection device 456 may be provided, such as a radio frequency (RF) emitter, for example. It should also be noted that it may not be possible to position displays at the intended position, in which case, an override may be provided to the viewer.

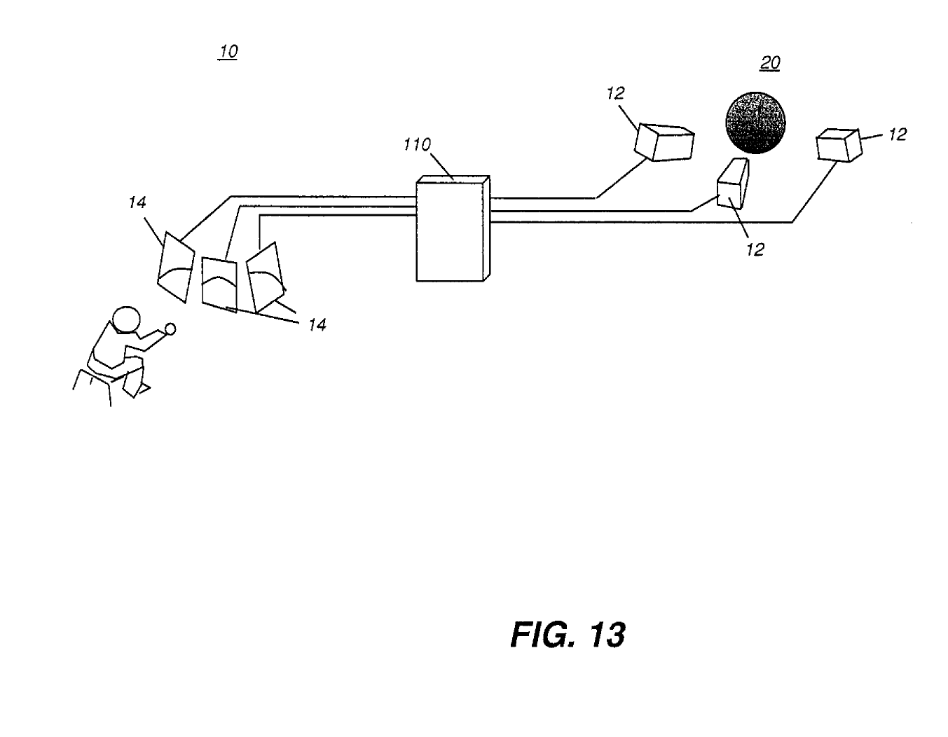

FIG. 13 is a block diagram of an imaging system 10 of the present invention in an alternate embodiment for coordinating the presentation of content data for a subject scene 20, from multiple perspectives. Subject scene 20 may be an object, such as is represented in FIG. 13, with one or more image-content generating devices 12 arrayed around the object for obtaining views of subject scene 20 from different perspectives. For this type of subject scene 20, the object that serves as subject scene 20 is centered and two or more image-content generating devices 12 are each aimed toward a generally centered object. Alternately, such as for a panoramic view (not shown), the observer is generally centered and image-content generating devices 12 are aimed outward from a centered location. For either of these configurations, as for the more generally planar configuration described earlier with reference to FIGS. 8-12, multiple image-content generating devices 12 provide different views of subject scene 20. Two or more display segments 14 then provide the different views obtained from image-content generating devices 12. Display segments 12 can be conventional display monitors, such as CRT or LCD displays, OLED displays, display screens associated with projectors or some other type of imaging display device. Image production system 110 coordinates the presentation of the multiple perspective content data for subject scene 20.

Still referring to FIG. 13, the spatial position of each display segment 14 is determined as described previously and thus is known to image production system 110, as well as the spatial position and field of view of each corresponding image-content generating device 12. For image production system 110, either or both of two types of control are exercised:
(i) a change of spatial position of display segment 14 causes a corresponding change of spatial position and field of view of its related image-content generating device 12; and
(ii) a change of spatial position and field of view of an image-content generating device 12 causes a corresponding change in spatial position of its related display segment 14.

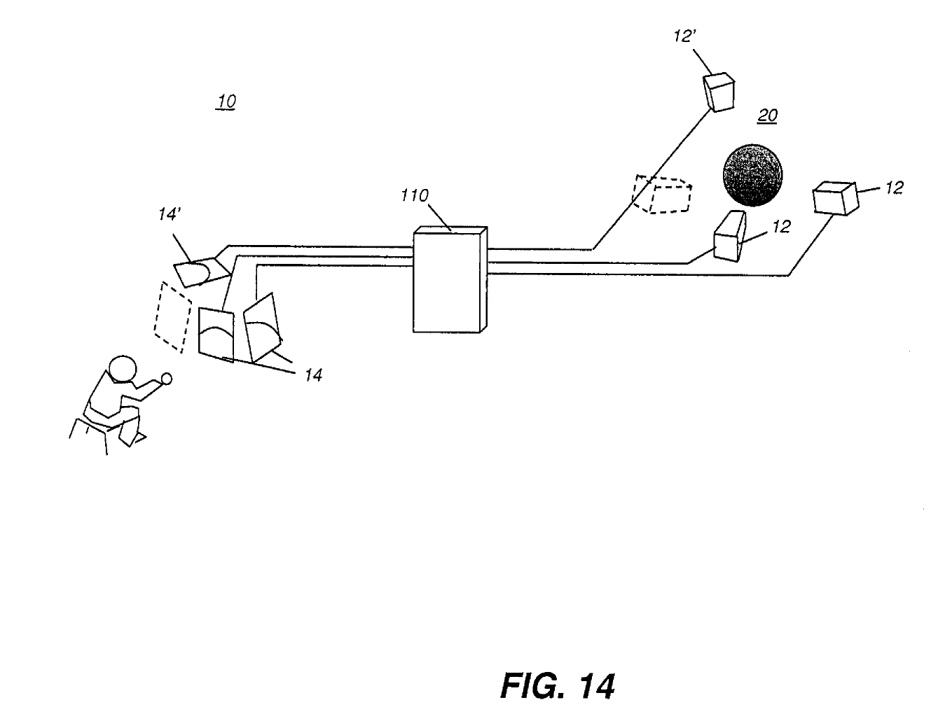

This relationship is shown in the block diagram of FIG. 14. The original positions of one of display segments 14′ and image-content generating devices 12′, both positions shown in dashed lines, are changed accordingly. In this example, subject scene 20 is viewed from a different perspective. Image production system 110 provides the logic control that tracks the field of view and spatial position of each image-content generating device 12 and 12′ and tracks the spatial view of its corresponding display segment 14 and 14′. Moreover, image production system 110 then exercises control over the positioning of either image-content generating devices 12 and 12′ and/or display segments 14 and 14′. Note that this embodiment is advantaged by the fact that the need for identifying the location of the viewer may be eliminated. Furthermore, to further enhance the effect of directional viewing, off-axis view limiting devices such as honeycomb screens or blinders may be affixed to the viewing surfaces of the displays so that the viewing angle is limited to that which corresponds to the capture angle.

Control of the position of either or both image-content generating devices 12 and their corresponding display segments 14 can be exercised in a discrete or continuous manner, either responding to movement following a delay or settling time, or responding to movement in a more dynamic way. In one embodiment, imaging system 10 provides a dynamic response to motion from any or all of the image-content generating device 12, or of the display segment 14, or of the viewer while in motion. This embodiment can be used to provide a type of virtual display environment. For example, a succession of cameras or other image-content generating devices 12 can be arranged along the path of viewer or subject motion to capture image content in more dynamic manner A succession of display segments 14 can be moved past a viewer or travel along with a viewer, adapting dynamically to the relative position of their corresponding image-content generating devices 12.

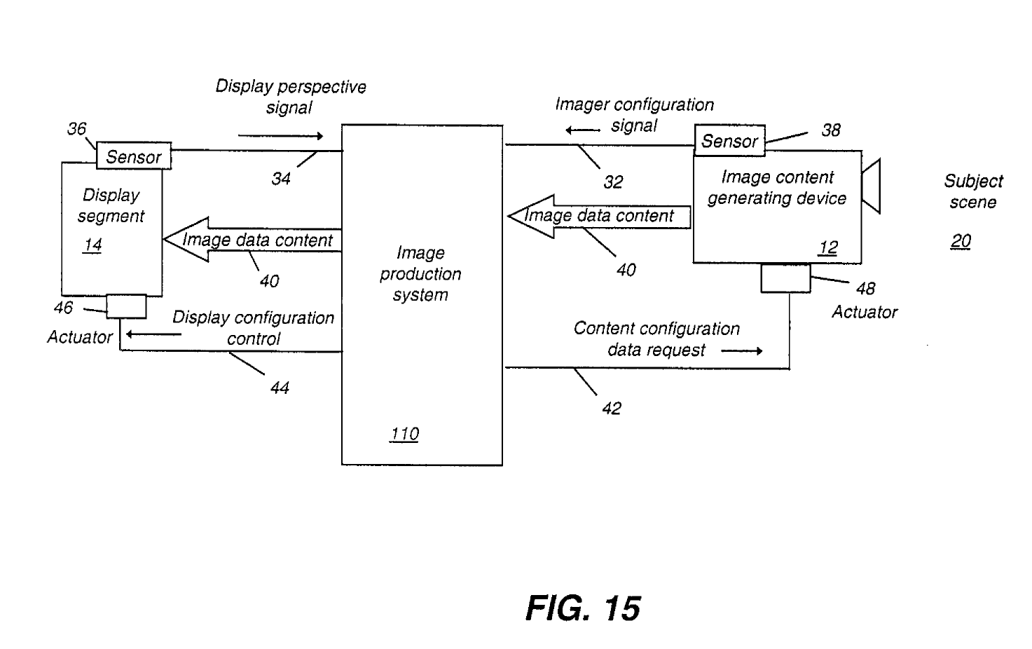

The block diagram of FIG. 15 shows the flow of data and control signals between image production system 110 and its peripheral image capture and display devices. FIG. 15 shows this signal and data flow for a single display segment 14 and its associated image-content generating device 12. Imaging system 110 has multiple display segments 14 and their corresponding image-content generating devices 12. It must be emphasized that the various data, control, and sensed signals can be combined together in any of a number of ways and may be transmitted using wired or wireless communication mechanisms. Display segments 14 and image-content generating devices 12 may be paired, so that there is a 1:1 correspondence, or may have some other correspondence. For example, there may be multiple image-content generating devices 12 associated with a single display segment 14 or multiple display segments 14 associated with a single image-content generating device 12. Thus, for example, a single camera or other image-content generating device 12 may be used to capture sequential images, displayed at two or more display segments 14 in succession. There may also be shared image and configuration data between display segments 14, such as to provide perspective views, for example. FIG. 15 shows these signals separately to help simplify discussion of imaging system 10 control embodiments overall.

As FIG. 15 shows, sensors 36 and 38 are provided for reporting the spatial position of display segment 14 and image-content generating device 12, respectively, using sensor signals 34 and 32. For image-content generating device 12, field of view (FOV) data is also provided, since this information provides useful details for determining the field of view and other viewing characteristics. Field of view may be determined, for example, using focal length setting for the imaging optics. Image data 40 flows from image-content generating device 12 to image production system 110, and thence to the corresponding display segment 14. Each display segment 14 and image-content generating device 12 can optionally have an actuator 46 and 48 respectively, coupled to it for configuring its spatial position according to an actuator control signal received from image production system 110. In the embodiment of FIG. 15, a configuration signal 42 is the actuator control signal that controls actuator 48; a configuration signal 44 is the actuator control signal that controls actuator 46.

An alternative to actuators 46 and 48 can be provided wherein one or both of configuration signals 42 and 44 provide visible or audible feedback to assist manual repositioning or other re-configuring of display segment 14 or of image-content generating device 12. Thus, for example, a viewer may listen for an audible signal that indicates when repositioning is required and may change in frequency, volume, or other aspect as repositioning becomes more or less correct. Or, a visible signal may be provided as an aid to repositioning or otherwise re-configuring either device.

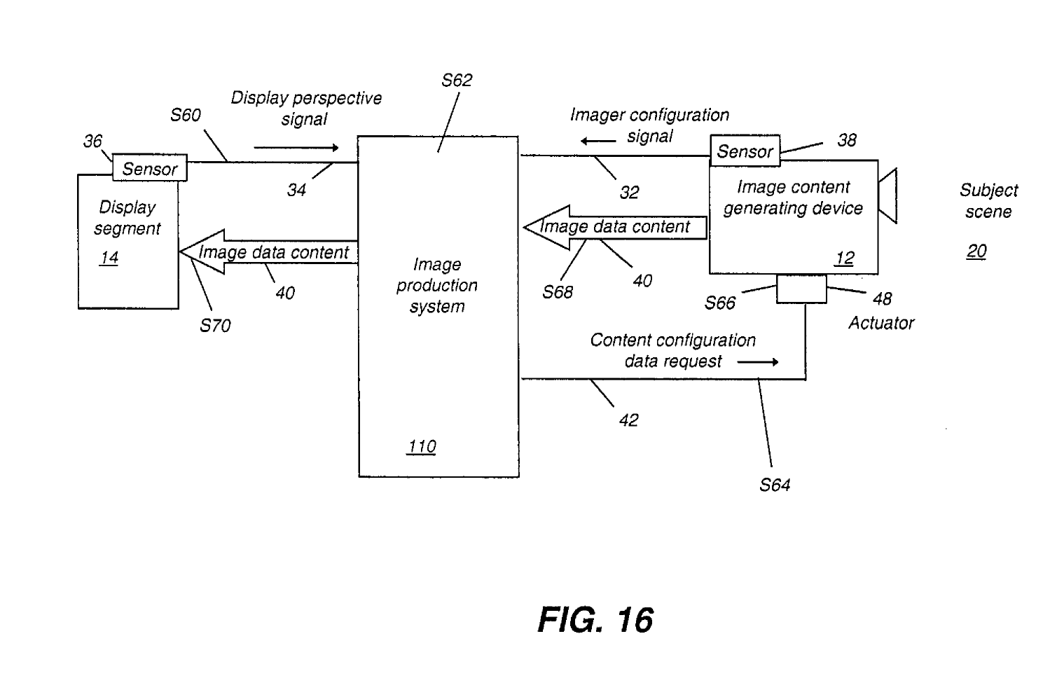

In one embodiment, the viewer of imaging system 10 manually positions display segments 14 into suitable position for viewing subject scene 20. The block diagram of FIG. 16 shows the sequence of signal handling that executes for this embodiment as steps S60 through S70 that indicate the corresponding signal or component related to each part of the sequence. In step S60, sensor signal 34 provides the display perspective signal corresponding to the spatial position of the moved display segment 14, such as a signal that indicates this display segment 14 position relative to a viewer position. The display perspective signal can include, for example, data on angular position and distance from a viewer position or relative to some other suitable reference position.

In step S62, image production system 110 processes this signal to generate a content configuration data request that takes the form of configuration signal 42 at step S64 and goes to actuator 48. In step S66, actuator 48 configures the position and field of view of image-content generating device 12 according to the content configuration data request. Sensor signal 32 provides the feedback to indicate positioning of image-content generating device 12. In step S68, image data from image-content generating device 12 goes to image production system 110 and is processed. Then, in step S70, the processed image data content 40 is directed to display segment 14. There may be iterative processing for appropriately positioning each device within the constraints of what is achievable. The content configuration data request can specify one or more of location, spatial orientation, date, time, zoom, and field of view, for example. The system determines the positions of the image-content generating devices 12 relative to each other and the positions of the display segments 14 relative to each other. In a preferred embodiment, positioning the image-content generating devices 12 repositions the display segments 14, and also positioning display segments 14 repositions image-content generating devices 12.

The system described with respect to the sequence of FIG. 16 can be useful in a number of applications for perspective viewing of subject scene 20, whether centered, planar, or panoramic. In medical imaging applications, for example, it may be useful for multiple cameras, image sensors, or other image generation apparatus to be spatially positionable by medical personnel, so that multiple displays of the same patient can be viewed from different perspectives at the same time. Other applications for which this capability can be of particular value may include imaging in hazardous environments, inaccessible environments, space exploration, or other remote imaging applications.

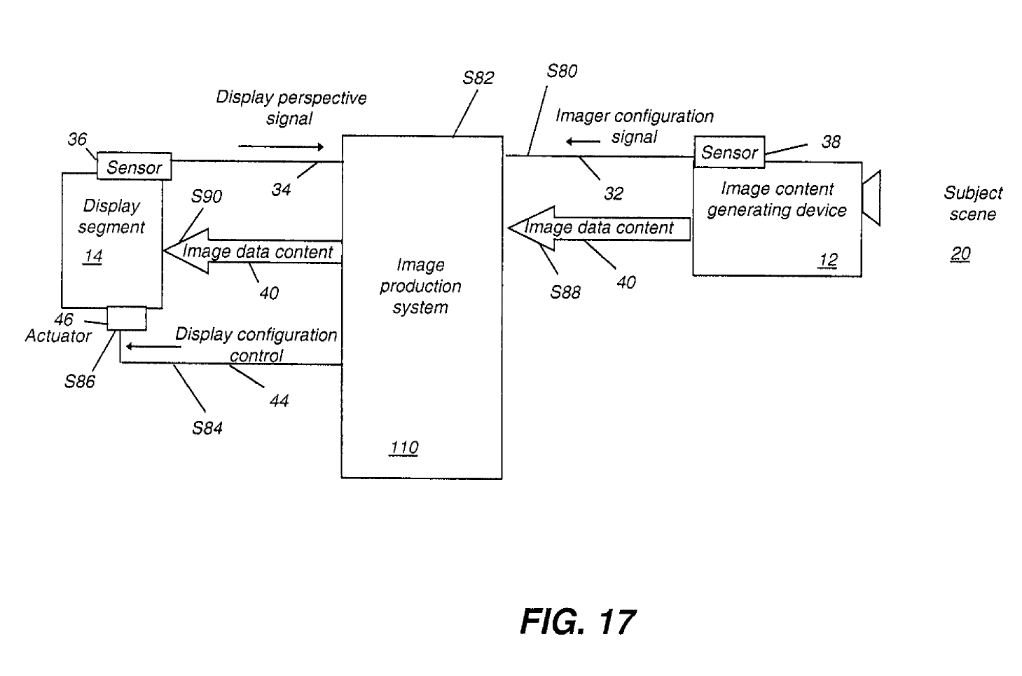

In another embodiment, the viewer of imaging system 10 manually positions image-content generating devices 12 into suitable position for viewing subject scene 20. The block diagram of FIG. 17 shows the sequence of signal handling that executes for this embodiment as steps S80 through S90 that indicate the corresponding signal or component related to each part of the sequence. In step S80, sensor signal 32 provides the signal that gives configuration data corresponding to the spatial position of moved image-content generating device 12. This signal may also indicate the field of view of image-content generating device 12. In step S82, image production system 110 processes this signal to generate a display configuration control signal that takes the form of configuration signal 44 at step S84 and goes to actuator 48. In step S86, actuator 48 configures the position and possibly the aspect ratio of display segment 14 according to the display configuration control signal. Sensor signal 34 provides the feedback to indicate positioning of display segment 14. In step S88, image data from image-content generating device 12 goes to image production system 110 and is processed. Then, in step S90, the processed image data content 40 is directed to display segment 14.

The embodiment described with reference to FIG. 17 can be useful, for example, in remote imaging applications where it is desirable to reposition display segment 14 according to camera position. An undersea diver, for example, might position multiple cameras about a shipwreck or other underwater debris or structure for which there are advantages to remote viewers in seeing multiple views spatially distributed and at appropriate angles. In another embodiment, multiple content generating devices 12 are positioned to generate a single image on a single display segment 14. This embodiment adapts techniques used in interactive conferencing, and described, for example, in U.S. Pat. No. 6,583,808 entitled “Method and System for Stereo Videoconferencing” to Boulanger et al., wherein multiple cameras obliquely directed toward a participant show the participant's face as if looking directly outward from the display. In the same way, multiple display segments 14 may show images obtained from the same image-content generating device 12.

Embodiments of the present invention can be used for more elaborate arrangements of display segments 14, including configurations in which display segments 14 are arranged along a wire cage or other structure that represents a structure in subject scene 20. This can include arrangements in which a number n (n≧1) of image-content generating devices 12 are arrayed and mapped to a number m display segments, wherein m≦n. Thus, for example, the image data from a particular camera would be processed and displayed only when a display segment 14 was suitably positioned for displaying the image for that camera. This arrangement would be useful in a motion setting, for example, such as where it is desired to observe the eye positions of a baseball batter as the ball nears the plate. Other methods for time-related or temporal control could also be employed, so that an image-content generating device 12 or corresponding display segment 14 is active only at a particular time.

Fly's-eye arrangements of image-content generating devices 12 could be provided, in which all cameras look outward and subject scene 20 surrounds the relative position of a viewer. Conversely, an inverse-fly's-eye arrangement of image-content generating devices 12 could be provided, in which an array of cameras surround subject scene 20.

The image data content that is received from image-content generating devices 12 can include both data from a camera image sensor and metadata describing camera position and aperture setting or other setting that relates to the camera's field of view.

In embodiments of the present invention, images obtained from the various image-content generating devices 12 can be obtained simultaneously, in real time, coordinated with movement of their corresponding display segments 14. Alternately, images need not be simultaneously captured, particularly where image-content generating devices 12 are separated over distances or where there is movement in the subject scene.

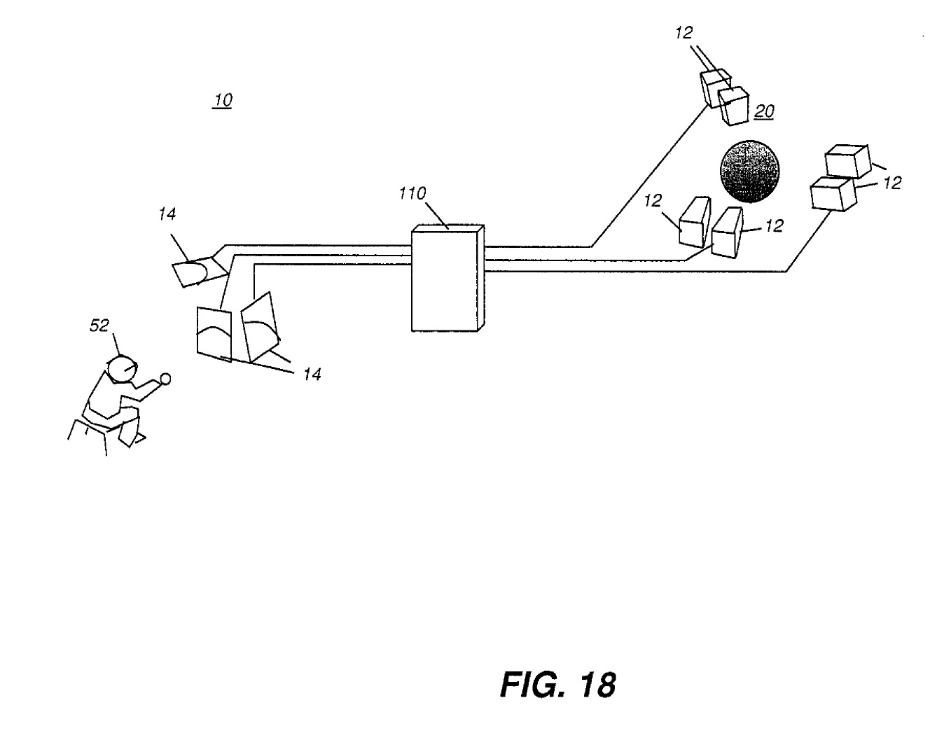

Embodiments of the present invention are capable of providing three-dimensional (3-D) imaging, as shown in the embodiment of FIG. 18. For 3-D perspective capture, two image-content generating devices 12 are typically used, one for capture of the image for the left eye of the viewer, the other for the right eye. Viewing glasses 52 or other suitable device are used to distinguish left-from right-eye image content, using techniques well known to those skilled in the imaging arts. For example, orthogonal polarization states can be provided for distinguishing left- and right-eye image content. In such an embodiment, viewing glasses 52 are equipped with corresponding orthogonal polarizers. Alternate image distinction methods include temporal methods that alternate left- and right-eye image content and provide the viewer with synchronized shutter glasses. In another alternate 3-D embodiment, spectral separation is used; in such a case, viewing glasses 52 are provided with filters for distinguishing the separate left- and right-eye image content.

The invention has been described in detail with particular reference to certain preferred embodiments thereof, but it will be understood that variations and modifications can be effected within the spirit and scope of the invention. For example, any of a number of different types of devices can be used as image-content generating devices 12 or as display segments 14. A computer could be used for generating synthetic images, for example. Real images and synthetic images could be combined or undergo further image processing for providing content to any display segment 14. Display segments 14 need not be planar segments, but may be flexible and have non-planar shapes. Any of a number of types of actuator could be used for automated re-positioning of image-content generating devices 12 or as display segments 14; however, actuators are optional and both could be manually adjusted, using some type of feedback for achieving proper positioning.

Thus, what is provided is a system and methods for coordinating the presentation of image content where there are multiple image-content generating and content display devices.

### PARTS LIST

10. Imaging system
12, 12′ Image-content generating device
14, 14′. Display segment
32, 34. Sensor signal
36, 38. Sensor
40. Image data
42, 44. Configuration signal
46, 48. Actuator
52. Viewing glasses
102. Data processing system
104. Data storage system
106. Peripheral system
107. Input system
108. User interface system
110. Image production system
200. Input
210. Image source
212, 214, 216. Image source
220. Audio source
222, 224, 226. Audio stream
230. Data source
232, 234, 236. Capture data
240. Other source
300. Output
310. Image output
320. Audio output
330. Data output
340. Other output
400. Scene
402. Mountain
404. Tree
406. Waterfall
410. Wall
420. Window
430, 440. Display
450, 452. Image-content generating device
454. Viewer
456. Viewer detection device
500. Locate step
510. Locate source cone of view step
520. Locate wall step
530. Locate window step
540. Locate observer step
550. Determination step
555. Step
560. Display step
S60, S62, S64, S66, S68, S70. Step
S80, S82, S84, S86, S88, S90. Step

What is claimed is:

1. A method for coordinating presentation of multiple perspective content data for a subject scene, comprising:
receiving separate display perspective signals, each corresponding to one of a plurality of display segments;
processing each of the separate display perspective signals to generate a corresponding content configuration data request;
configuring at least one image-content generating device according to the corresponding content configuration data request; and
obtaining image data content of the subject scene from the at least one image-content generating device.

2. The method of claim 1 wherein configuring the at least one image-content generating device according to the corresponding content configuration data request comprises adjusting one or more of spatial position and field of view of the image-content generating device.

3. The method of claim 1 wherein one or more of the display segments are automatically movable.

4. The method of claim 1 wherein the at least one image-content generating device is a camera.

5. The method of claim 1 wherein the at least one image-content generating device is a computer that generates synthetic images.

6. The method of claim 1 wherein image data content is received simultaneously from two or more image-content generating devices.

7. The method of claim 6 wherein the image data content provides a three-dimensional image of the subject scene.

8. The method of claim 1 wherein the at least one image-content generating device is automatically movable.

9. The method of claim 1 wherein the display perspective signal is indicative of field of view.

10. The method of claim 1 further comprising displaying the obtained image data content on one or more of the display segments.

11. The method of claim 1 wherein the content configuration data request specifies one or more of location, spatial orientation, date, time, and field of view.

12. The method of claim 1 further comprising providing audible or visual feedback for configuring the at least one image-content generating device.

13. A method for coordinating presentation of multiple perspective content data, comprising:
obtaining image data content representative of a subject scene from each of at least one image-content generating device, wherein the image data content comprises configuration data related to at least the spatial position of the image-content generating device;
configuring the spatial position of at least one display segment according to the configuration data; and
displaying an image on the at least one display segment according to the obtained image data content.

14. The method of claim 13 further comprising providing audible or visual feedback for configuring the spatial position of the at least one display segment.

15. The method of claim 13 wherein configuring the spatial position of at least one display segment comprises energizing an actuator that is coupled to the at least one display segment.

16. An apparatus for displaying content data for a subject scene comprising:
two or more display segments, each display segment coupled to a display position sensor that provides a display perspective signal according to the position of the display segment;
two or more image-content generating devices, wherein at least one of the image-content generating devices is coupled to a first actuator that is actuable for positioning the at least one image-content generating device according to an actuator control signal; and
a control logic processing system that provides the actuator control signal to the first actuator for positioning the at least one image-content generating device in response to the provided display perspective signal.

17. The apparatus of claim 16 further comprising:
a second actuator coupled to at least one of the two or more display segments and actuable for positioning the at least one display segment according to a display configuration control signal; and
an image-content generating device position sensor coupled to at least one of the two or more image-content generating devices, the image-content generating device position sensor disposed to provide an imager configuration signal according to the position of the at least one image-content generating device;
wherein the control logic processing system further provides the display configuration control signal in response to the provided imager configuration signal.

18. The apparatus of claim 16 wherein at least one of the image-content generating devices is a camera.

19. An apparatus for displaying content data for a subject scene comprising:
two or more image-content generating devices, wherein each image-content generating device is coupled to an image-content generating device position sensor, each image-content generating device position sensor disposed to provide an imager configuration signal according to the position of its corresponding image-content generating device;
two or more display segments, each display segment coupled to an actuator that is actuable for positioning the corresponding display segment according to a display configuration control signal; and
a control logic processing system that provides the display configuration control signal to each display segment in response to the imager configuration signal from a corresponding image-content generating device.

20. The apparatus of claim 19 wherein at least one of the image-content generating devices is a camera.
